(19) United States
(12) Patent Application Publication
(10) Pub. No.: US 2026/0210822 A1
(43) Pub. Date: Jul. 23, 2026

(54) Test Method and Test System for Chairs

(71) Applicant: Teng-Jen Yang, Taichung City (TW)

(72) Inventor: Teng-Jen Yang, Taichung City (TW)

(21) Appl. No.: 19/032,180

(22) Filed: Jan. 20, 2025

(51) Int. Cl. G01N 3/34; B25J 9/16

(52) U.S. Cl. CPC G01N 3/34; B25J 9/1679; G01N 2203/0005; G01N 2203/0032; G01N 2203/0069; G01N 2203/0208; G01N 2203/0262; G01N 2203/0676

(57) ABSTRACT

A test method for a chair is suitable for testing the properties of a chair part of the chair, and includes the following steps: controlling a robotic arm to drive a pressuring member to approach and push against a sample associated with the chair part; controlling a force sensor to detect a reaction force transmitted from the pressuring member pushing against the sample, to generate a force sensing value; receiving the force sensing value from the force sensor to determine whether the force sensing value reaches a set value that is related to human's weight; and controlling the robotic arm to drive the pressuring member to leave the sample, when the force sensing value reaches the set value; The above steps are performed by a server repeatedly executing a test procedure according to a preset number of tests.

### BACKGROUND

### Field of the Invention

The present invention relates to product testing technology, and more particularly to a test method and test system for chairs.

### Description of Related Art

The current product testing technology used to test the properties of seats has entered the automation stage. For example, in testing the endurance of a seat back, as shown in FIG. 1, when the lower portion 12 of the seat back 11 is fixed, the upper portion 13 of the seat back 11 is continuously pulled backward with a preset tension by a test machine 21 until the seat back 11 is damaged. For example, in testing the durability and quality of a chair cushion, as shown in FIG. 2, when the seat 14 is placed under a heavy object 23 suspended by a test machine 22, the test machine 22 is used to repeatedly release and lift the heavy object 23, so that the heavy object 23 repeatedly impacts the seat 14 until the seat 14 is damaged.

However, the existing product testing technologies are not developed based on the imitation of the real usage conditions of users (for example, but not limited to, the state of shifting of center of gravity of a sitter with respect to the chair cushion, the state of shifting of position of pressing on the seat back, the weight of the sitter, the body size of the user, or the different sitting time each time), and difficulty ensures that the chair part(s) (for example, but not limited to, the seat back or seat) can stably bear the fixed force (for example, but not limited to, the thrust, pulling force, compressive force or impact force), and therefore, it is more difficult to test the properties exhibited by the seat in actual use.

### SUMMARY

One of the objectives of the present invention is to provide a test method and test system for a chair, which is able to, by enabling a chair part to be tested to stably bear a fixed force, solve the problem in the prior art that a chair part cannot stably bear a fixed force. Thus, the test results reflect or are closer to the properties (such as, but not limited to, performance, quality, nature, attributes, etc.) exhibited by the chair part in actual use.

To achieve the above objective, a test system for a chair provided in accordance with an embodiment of the present invention is suitable for testing properties of a chair part by using a sample associated with a chair part of the chair and includes: a pressuring member; a force sensor connected to the pressuring member; a robotic arm connected to the force sensor; and a server communicable with the force sensor and the robotic arm to repeatedly execute a test procedure according to a preset number of tests to test the sample, and whenever the test procedure is executed, the server configured to: control the robotic arm to drive the pressuring member to approach and push against the sample; control the force sensor to detect a reaction force transmitted from the pressuring member pushing against the sample, to generate a force sensing value; receive the force sensing value from the force sensor to determine whether the force sensing value reaches a set value that is related to human’s weight; and control the robotic arm to drive the pressuring member to leave the sample, when the force sensing value reaches the set value.

The present invention determines the timing that the pressuring member should leave the sample, by detecting whether the reaction force reaches the set value, so as to let the chair part to be tested to stably bear a fixed force, so that the test results can be closer to or reflect the properties exhibited by the chair part in actual use.

Optionally, the server controls the robotic arm to drive the pressuring member to simulate a human body movement to approach and push against the sample, and the human body movement refers to a movement of a human sitting down. Thus, the present invention can achieve highly realistic testing, so that the test results can be closer to or reflect the properties exhibited by the chair part in actual use.

Optionally, the pressuring member has a movement trajectory when moving according to the human body movement, the movement trajectory includes a forward path, the forward path starts from an initial coordinate far away from the seat sample, through a surface contact coordinate, to an arrival coordinate of normal push, the arrival coordinate of normal push is farther from the initial coordinate than the surface contact coordinate, the pressuring member initially contacts the contact surface of the seat sample when located at the surface contact coordinate, and the force sensing value reaches the set value when the pressuring member is located at the arrival coordinate of normal push; the movement trajectory further includes a lateral path following the forward path, the lateral path is from the arrival coordinate of normal push to an arrival coordinate of oblique push, the arrival coordinate of oblique push is farther from the initial coordinate than the surface contact coordinate, when the pressuring member is located at the arrival coordinate of oblique push, the force sensing value reaches the set value; and when the movement trajectory is completed and the force sensing value reaches the set value, the server controls the robotic arm to drive the pressuring member to leave the sample. Thus, the present invention can achieve highly realistic testing, so that the test results can be closer to or reflect the properties exhibited by the chair part in actual use.

Optionally, the movement trajectory further includes a turning path following the lateral path, the turning path is from the arrival coordinate of oblique push back to the arrival coordinate of normal push; and the movement trajectory further includes another lateral path following the turning path, the another lateral path is from the arrival coordinate of normal push to another arrival coordinate of oblique push, the another arrival coordinate of oblique push is farther from the initial coordinate than the surface contact coordinate, and the arrival coordinate of normal push is located between the arrival coordinates of oblique push, and when the pressuring member is located at the another arrival coordinate of oblique push, the force sensing value reaches the set value. Thus, the present invention can achieve highly realistic testing, so that the test results can be closer to or reflect the properties exhibited by the chair part in actual use.

Optionally, the test procedure includes a time parameter of push, the time parameter of push instructs the server to control the pressuring member to continuously push the sample so that the force sensing value continues to reach the set value for a period of time. Thus, the present invention can achieve highly realistic testing, so that the test results can be closer to or reflect the properties exhibited by the chair part in actual use.

Optionally, the sample imitates multiple chair parts of the chair and is used to test the properties of any one of the chair parts, and these chair parts are allowed to be assembled together or form an integrally formed structure. Thus, the time consumed for replacing the sample can be saved, thereby increasing the efficiency of product testing.

Optionally, the sample imitates multiple chair parts of the chair and is used to test the properties of these chair parts at the same time, and these chair parts are allowed to be assembled together or form an integrally formed structure. Thus, the time consumed for replacing the sample can be saved, thereby increasing the efficiency of product testing.

Optionally, the chair part is a seat back, a seat, a cushion, an armrest, a headrest, a chair leg, a lifting column or a wheel.

Optionally, the pressuring member is an imitation of body parts, the imitation of body parts includes a pressuring surface for contacting the sample, a surface shape of the pressuring surface imitates a surface shape of a human body part used to contact the chair part. Thus, the present invention can achieve highly realistic testing, so that the test results can be closer to or reflect the properties exhibited by the chair part in actual use.

Optionally, when the chair part is a seat back, the surface shape of the pressuring surface of the imitation of body parts imitates a surface shape of the human back. Thus, the present invention can achieve highly realistic testing, so that the test results can be closer to or reflect the properties exhibited by the chair part in actual use.

Optionally, when the chair part is a seat, the surface shape of the pressuring surface of the imitation of body parts imitates surface shapes of buttocks and thigh roots. Thus, the present invention can achieve highly realistic testing, so that the test results can be closer to or reflect the properties exhibited by the chair part in actual use.

Furthermore, according to an embodiment, the present invention also provides a testing method for a chair, which is suitable for the above testing system to test the properties of a chair part of the chair.

Additionally, according to an embodiment, the present invention also provides another test method for chairs, which is suitable for testing the properties of a chair part of the chair, and includes the following steps: (A) controlling a robotic arm to drive a pressuring member to approach and push against a sample associated with the chair part; (B) controlling a force sensor to detect a reaction force transmitted from the pressuring member pushing against the sample, to generate a force sensing value; (C) receiving the force sensing value from the force sensor to determine whether the force sensing value reaches a set value that is related to human's weight; and (D) controlling the robotic arm to drive the pressuring member to leave the sample, when the force sensing value reaches the set value. The steps (A) to (D) are performed by a server repeatedly executing a test procedure according to a preset number of tests.

Optionally, in the step (A), the robotic arm drives the pressuring member to simulate a human body movement to approach and push against the sample, and the human body movement refers to the movement of a human sitting down. Thus, the present invention can achieve highly realistic testing, so that the test results can be closer to or reflect the properties exhibited by the chair part in actual use.

Optionally, the pressuring member has a movement trajectory when moving according to the human body movement, the movement trajectory includes a forward path, the forward path starts from an initial coordinate far away from the seat sample, through a surface contact coordinate, to an arrival coordinate of normal push, the arrival coordinate of normal push is farther from the initial coordinate than the surface contact coordinate, the pressuring member contacts the contact surface of the seat sample when located at the surface contact coordinate, , and the force sensing value reaches the set value when the pressuring member is located at the arrival coordinate of normal push; the movement trajectory further includes a lateral path following the forward path, the lateral path is from the arrival coordinate of normal push to an arrival coordinate of oblique push, the arrival coordinate of oblique push is farther from the initial coordinate than the surface contact coordinate, and the force sensing value reaches the set value when the pressuring member is located at the arrival coordinate of oblique push; and in the step (D), when the movement trajectory is completed and the force sensing value reaches the set value, the server controls the robotic arm to drive the pressuring member to leave the sample. Thus, the present invention can achieve highly realistic testing, so that the test results can be closer to or reflect the properties exhibited by the chair part in actual use.

Optionally, the movement trajectory further includes a turning path following the lateral path, the turning path is from the arrival coordinate of oblique push back to the arrival coordinate of normal push; and the movement trajectory further includes another lateral path following the turning path, the another lateral path is from the arrival coordinate of normal push to another arrival coordinate of oblique push, the another arrival coordinate of oblique push is farther from the initial coordinate than the surface contact coordinate, and the arrival coordinate of normal push is located between the arrival coordinates of oblique push, and when the pressuring member is located at the another arrival coordinate of oblique push, the force sensing value reaches the set value. Thus, the present invention can achieve highly realistic testing, so that the test results can be closer to or reflect the properties exhibited by the chair part in actual use.

Optionally, the test procedure includes a time parameter of push, the time parameter of push instructs the server to control the pressuring member to continuously push the sample so that the force sensing value continues to reach the set value for a period of time. Thus, the present invention can achieve highly realistic testing, so that the test results can be closer to or reflect the properties exhibited by the chair part in actual use.

Optionally, the sample imitates multiple chair parts of the chair and is used to test the properties of any one of the chair parts, and these chair parts are allowed to be assembled together or form an integrally formed structure. Thus, the time consumed for replacing the sample can be saved, thereby increasing the efficiency of product testing.

Optionally, the sample imitates multiple chair parts o f the chair and is used to test the properties of these chair parts at the same time, and these chair parts are allowed to be assembled together or form an integrally formed structure. Thus, the time consumed for replacing the sample can be saved, thereby increasing the efficiency of product testing.

Optionally, the chair part is a seat back, a seat, a cushion, an armrest, a headrest, a chair leg, a lifting column or a wheel.

Optionally, the pressuring member is an imitation of body parts, the imitation of body parts includes a pressuring surface for contacting the sample, and a surface shape of the pressuring surface imitates a surface shape of a body part used to contact the chair part. Thus, the present invention can achieve highly realistic testing, so that the test results can be closer to or reflect the properties exhibited by the chair part in actual use.

Optionally, when the chair part is a seat back, the surface shape of the pressuring surface of the imitation of body parts imitates a surface shape of human back; and when the chair part is a seat, the surface shape of the pressuring surface of the imitation of body parts imitates surface shapes of buttocks and thigh roots. Thus, the present invention can achieve highly realistic testing, so that the test results can be closer to or reflect the properties exhibited by the chair part in actual use.

### BRIEF DESCRIPTION OF THE DRAWINGS

After studying the detailed description in conjunction with the following accompanying drawings, other aspects and advantages of the present invention will be discovered:

FIG. 1 is a schematic diagram of a testing system of the prior art applied to a chair for testing the properties of a seat back;

FIG. 2 is a schematic diagram of a testing system of the prior art applied to a chair for testing the properties of a seat;

FIG. 3 is a functional block diagram of a testing system for a chair according to an embodiment of the present invention;

FIG. 4 is a perspective view of a part of the testing system for a chair according to an embodiment of the present invention;

FIG. 5 is a flowchart of a testing method for a chair according to an embodiment of the present invention;

FIG. 6 is a flowchart of a testing method for a chair according to an embodiment of the present invention;

FIG. 7 is a side view of the testing system of FIG. 4 in testing a seatback sample;

FIG. 8 is a top view of the testing system of FIG. 4 in testing a seatback sample, to present the state where the simulated back object is normally pushing the seatback sample at the arrival coordinate of normal push under the condition of simulating a normal sitting posture;

FIG. 9 is a top view of the testing system of FIG. 4 in testing a seatback sample, to present the state where the simulated back object is obliquely pushing the seatback sample at one of the arrival coordinates of oblique push under the condition of simulating an improper sitting posture;

FIG. 10 is a top view of the testing system of FIG. 4 in testing a seatback sample, to present the state where the simulated back object is obliquely pushing the seatback sample at another one of the arrival coordinates of oblique push under the condition of simulating an improper sitting posture;

FIG. 11 is a schematic diagram of the movement trajectory at a view point in the case of simulating a normal sitting posture according to an embodiment of the present invention;

FIG. 12 is a schematic diagram of the movement trajectory at a view point in the case of simulating normal and improper sitting postures according to an embodiment of the present invention;

FIG. 13A is a schematic diagram of a testing system for a chair and a seatback sample to be tested according to an embodiment of the present invention;

FIG. 13B is a schematic diagram of a part of the testing system of FIG. 13A;

FIG. 14 is a side view of the testing system of FIG. 13A in testing a seatback sample;

FIG. 15 is a top view of the testing system of FIG. 13A when testing a seatback sample to present the state where the simulated hip-leg object is obliquely pushing against the seatback sample at one of the arrival coordinates of oblique push under the condition of simulating an improper sitting posture;

FIG. 16 is a top view of the testing system of FIG. 13A in testing a seatback sample, to present the state where the simulated hip-leg object is obliquely pushing the seatback sample at another one of the arrival coordinates of oblique push under the condition of simulating an improper sitting posture;

FIG. 17 is a schematic diagram of the movement trajectory at a view point in the case of simulating a normal sitting posture according to an embodiment of the present invention;

FIG. 18 is a schematic diagram of the movement trajectory at a view point in the case of simulating normal and improper sitting postures according to an embodiment of the present invention;

FIG. 19 is a waveform diagram of the force sensing value changing with time according to an embodiment of the present invention; and

FIGS. 20A to 20D are different examples of samples applicable to the present invention.

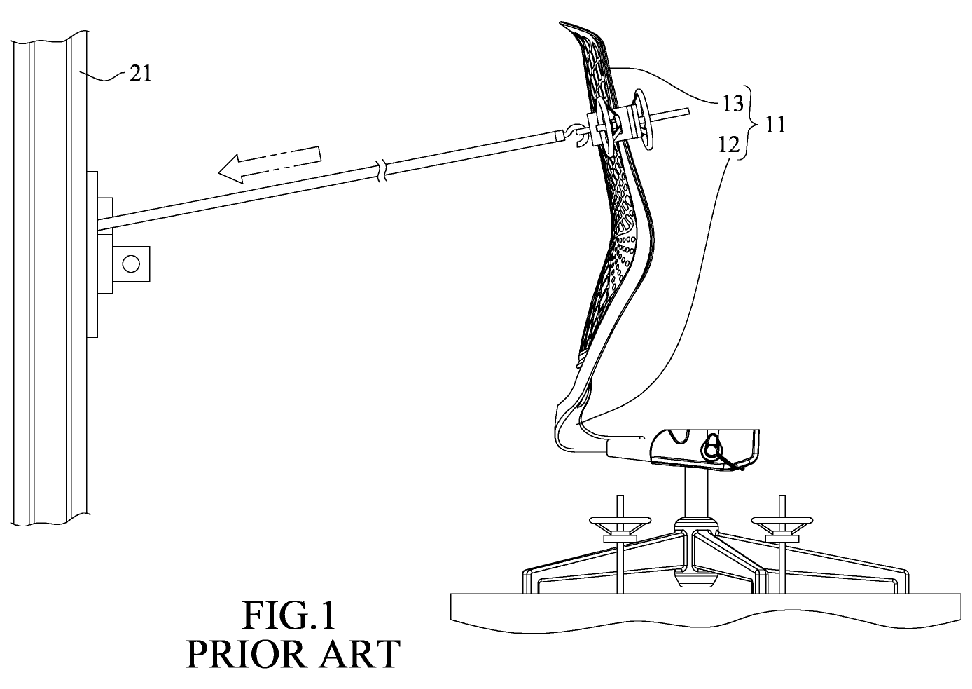

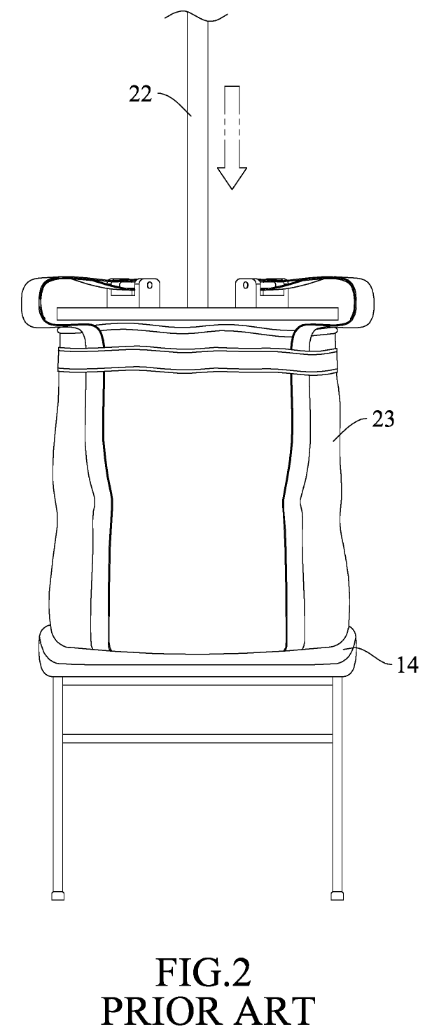

### DETAILED DESCRIPTION

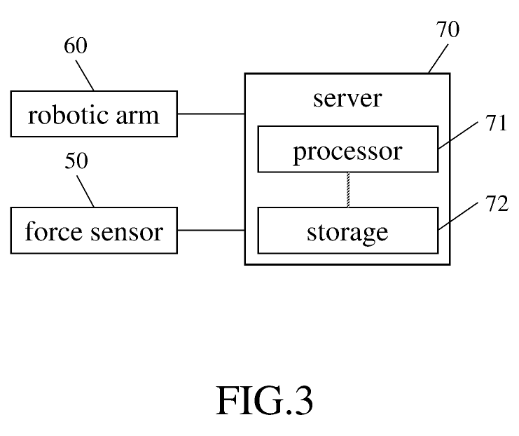

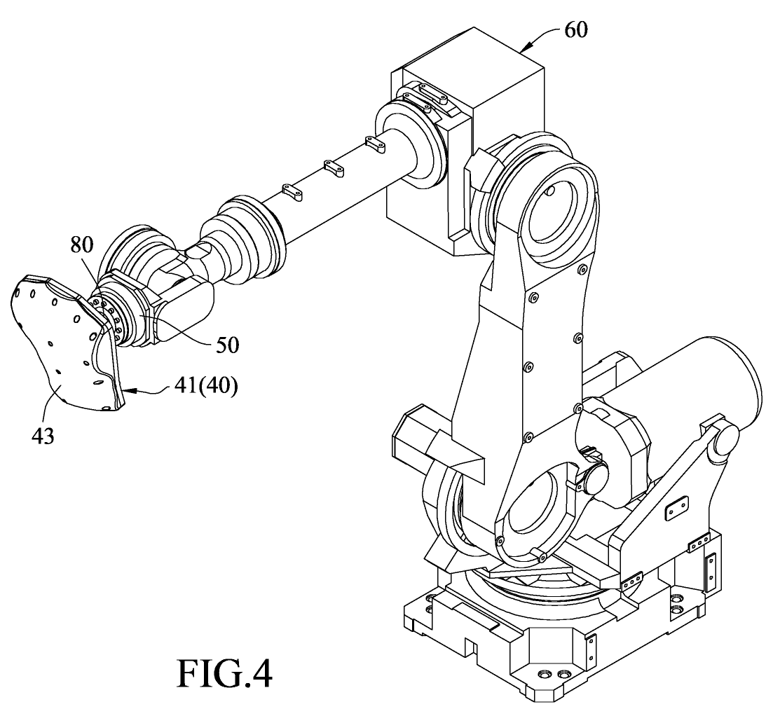

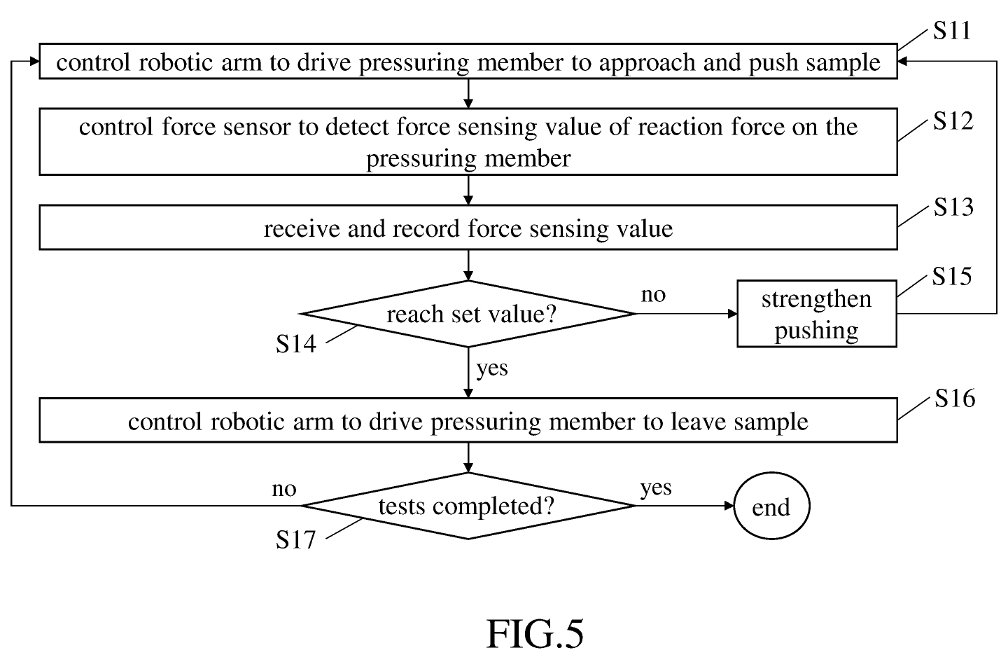

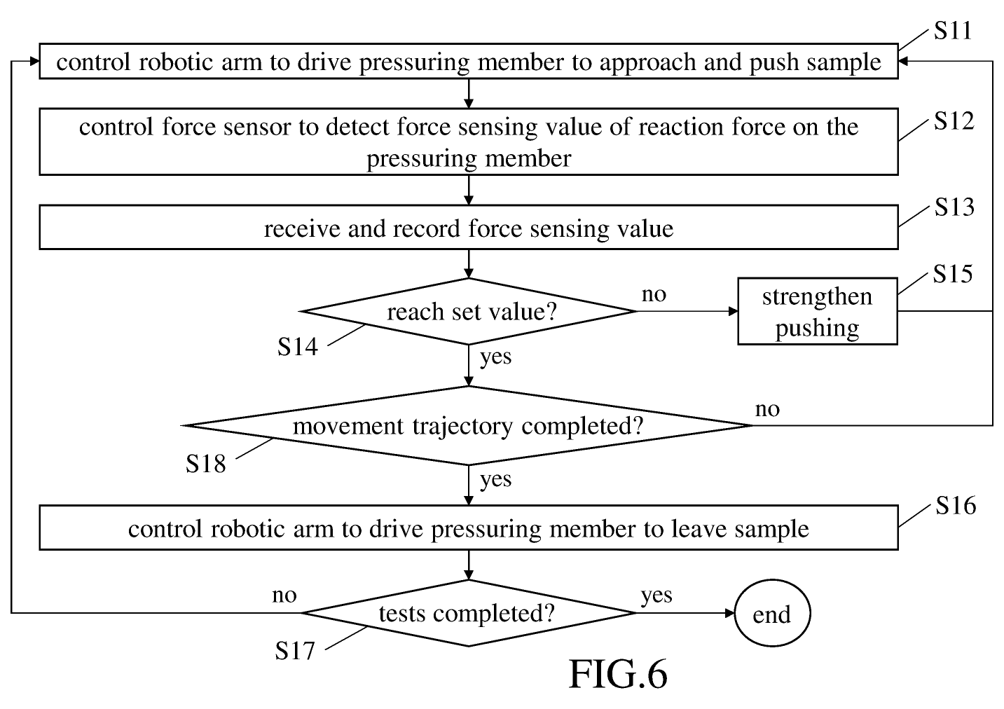

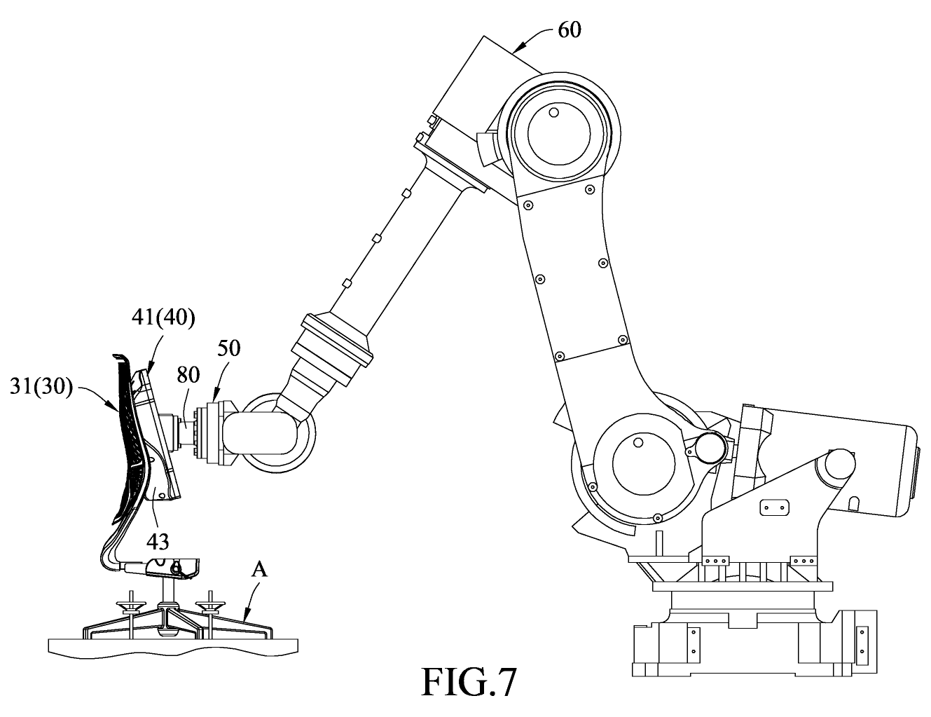

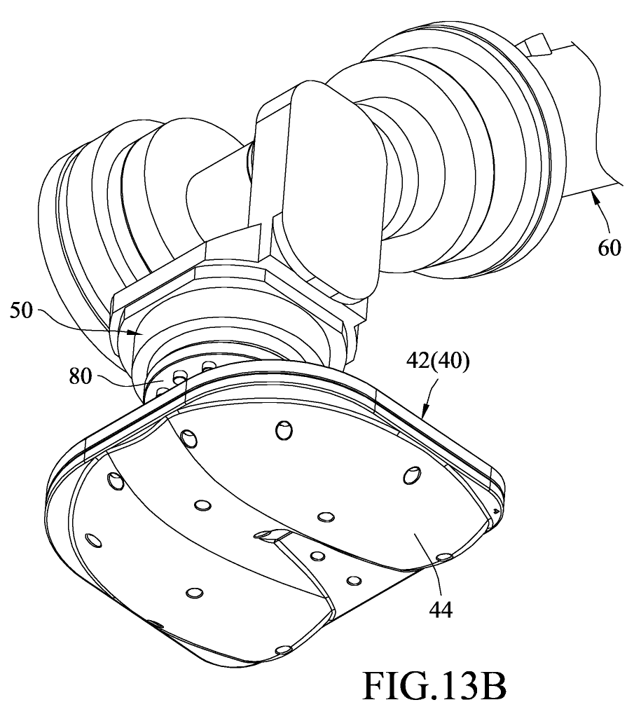

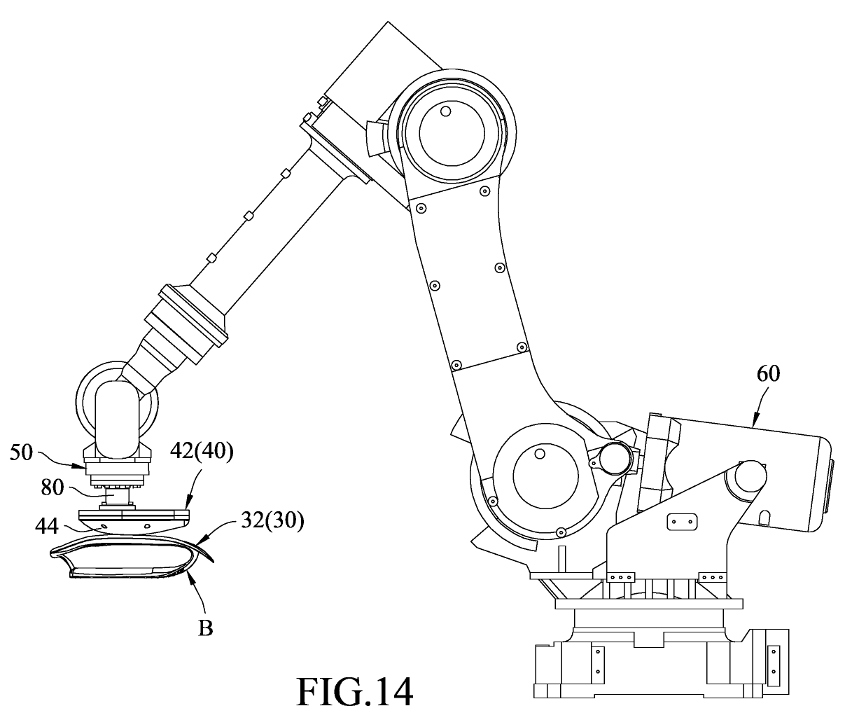

Referring to FIGS. 3 to 19, a test system and a test method for a chair according to one or more embodiments of the present invention are suitable for automatically testing the properties of a chair part of the chair, and can achieve the desired test purpose by testing a sample 30 associated with the chair part.

The present invention does not limit the type of applicable chairs, so the chair type is, for example but not limited to, a high chair, an office chair, an electronic gaming chair, a folding chair, a chair stool or other type of chairs. Similarly, the present invention does not limit the type of chair part to be tested, so the type of the sample 30 is, for example but not limited to, a seat back, a seat, a cushion, an armrest, a headrest, a chair leg, a lifting column, wheels or other parts of the chair. Furthermore, the sample 30 may be a chair part that can be directly assembled to a chair, or a sample that cannot be assembled to a chair and is substantially similar to (the material, size and structure of the main body are the same as) a chair part.

For the purpose of a brief explanation, the samples 30 to be tested in the following embodiments or examples are all samples that cannot be installed to a chair and are substantially similar to (the material, size and structure of the main body are the same as) a chair part.

The test system of the present invention includes, for example, but not limited to, a pressuring member 40, a force sensor 50, a robotic arm 60 and a server 70. The server 70 can communicate with the force sensor 50 and the robotic arm 60, thereby controlling the operation of the force sensor 50 and the robotic arm 60.

The pressuring member 40 is driven to push or press the sample 30, and includes a pressuring surface for contacting the sample 30. In the present invention, an appropriate pressuring member 40 can be selected according to the type of the sample 30 to be tested. For example, when the sample 30 is a chair part (such as but not limited to the seat back, seat, headrest, cushion, etc.) that imitates the part of a chair that the user can touch and lean against (or press down), an object imitating a human’s body part can be selected as the pressuring member 40, so that the surface shape of the pressuring surface of the pressuring member 40 is an imitation of the surface shape of the body part used to contact the sample 30.

For the purpose of a brief explanation, the following examples of chair parts imitated by the sample 30 are the seat back and the seat. The sample 30 imitating the back of a chair is defined as a seatback sample 31, and the sample 30 imitating the seat is defined as a seat sample 32.

In the case of testing the seatback sample 31, a simulated back object 41 can be selected as the pressuring member 40, and the surface shape of the pressuring surface 43 of the pressuring member 41 imitates the surface shape of the back of the human body for contacting the seatback sample 31. Optionally, the size and material of the simulated back object 41 are also designed to imitate the size and hardness of the back of human body.

In the case of testing the seat sample 32, a simulated hip-leg object 42 can be selected as the pressuring member 40, and the surface shape of the pressuring surface 44 of the simulated hip-leg object 42 imitates the surface shapes of the buttocks and thigh roots of the human body for contacting the seat sample 32. Optionally, the size and material of the simulated hip-leg object 42 are also designed to imitate the sizes and hardness of the hip and thigh of the human body.

The end of the force sensor 50 close to the robotic arm 60 can be fixed (for example, but not limited to, screwed) to the terminal portion of the robotic arm 60, and the pressuring member 40 can be fixed (for example, but not limited to, screwed) to the end of the force sensor 50 away from the robotic arm 60 through a connecting member 80, so that the force sensor 50 can detect the reaction force (for example, the reaction force on the Z axis) on the pressuring member 40. In the present invention, the force sensor 50 can be a single-axis force sensor or a multi-axis force sensor.

The robotic arm 60 can be any type of automated handling equipment that can move an object in space.

The server 70 includes a processor 71 and a storage 72 electrically connected to the processor 71. In the storage 72, at least one database can be pre-established to store programs, instructions, algorithms and parameters required for operation of the present invention so that the processor 71 can use them to execute test tasks. The content stored in the database may depend on, for example but not limited to, the type of sample 30 and the type of test task. The test task may be, for example but not limited to, endurance test, material strength test, etc.

The following is an exemplary description of the test system executing the test method of the present invention. This test method includes at least the following steps.

Step S11: controlling, by the processor 71 of the server 70, the robotic arm 60 to drive the pressuring member 40 to approach and push against the sample 30. The sample 30 is fixed on a fixture (e.g., fixed to the fixture A and fixture B on a test machine).

Step S12: controlling, by the processor 71, the force sensor 50 to detect the reaction force transmitted from the pressuring member 40 pushing against the sample 30, so as to generate a force sensing value.

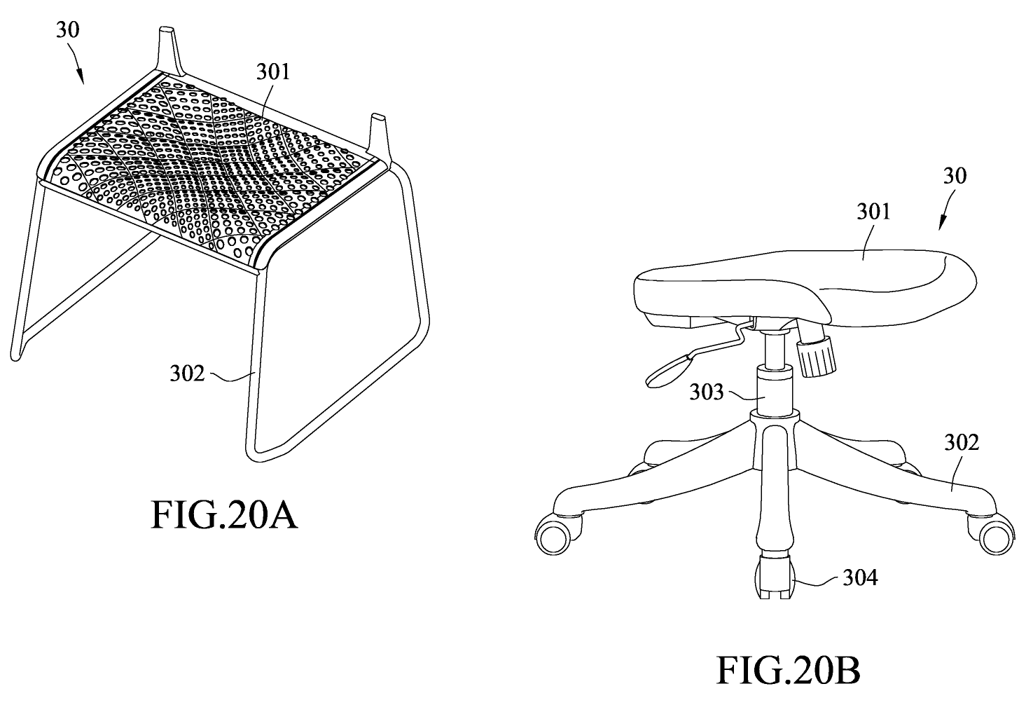

Step S13: receiving and recording, by the processor 71, the above force sensing value from the force sensor 50. For example, the curve C shown in FIG. 19 is the result of recording the change of the force sensing value over time by the processor 71; and in the curve C, the force sensing values on the line segment in the trough area R all reach (greater than or equal to) -627.7N.

Step S14: determining, by the processor 71, whether the force sensing value reaches a set value. This set value is related to human's weight, for example but not limited to, -627.7N, which is equivalent to human's weight of 64Kg.

Step S15: when the force sensing value of step S14 has not reached the set value, it means that the processor 71 still needs to control the robotic arm 60 to keep driving the pressuring member 40 to push (i.e., push forward) the sample 30. In addition to letting the pressuring member 40 to push the sample 30 more, the processor 71 returns to step S11 and continues to repeatedly execute steps S11 to S15 until the detected force sensing value reaches the set value.

Step S16: when the force sensing value in step S14 reaches the set value, the processor 71 further controls the robotic arm 60 to drive the pressuring member 40 to leave the sample 30.

Since the above steps S11 to S16 are steps to be done as a test procedure defined in a test procedure is executed once, the processor 71 will count up or down once whenever the above step S16 is completed. Counting up means gradually increasing from zero to a preset number of tests, so counting once means adding one into an accumulative total. Counting down means gradually decreasing from a preset number of tests to zero, so counting once means subtracting one from an accumulative total. The preset number of tests is defined in the test program for the above test procedure.

Step S17: determining, by the processor 71, whether the preset number of tests has been completed, based on the current counting result. If it has not been completed yet, the processor 71 returns to step S11 to execute the above test procedure again, that is, to execute steps S11 to S16 again. If it has been completed, this means that the test task defined by the above test program has been completed, so that the processor 71 controls the force sensor 50 and the robotic arm 60 to stop operating.

Optionally, the above steps S11 and S12 can be executed synchronously. In this way, during the movement of the pressuring member 40, the processor 71 can determine whether the pressuring member 40 contacts the contact surface of the sample 30, from the change in the detection result of the force sensor 50, and can also determine whether the pressure applied to the sample 30 meets the expectation.

Optionally, in the above step S11, the robotic arm 60 may drive the pressuring member 40 to simulate a human body movement to approach and push against the sample 30. The human body movement refers to the movement of a human sitting down. The following example is used for illustration.

### Example 1

In the example where the sample 30 is a seatback sample 31, the robotic arm 60 may drive the simulated back object 41 to contact and push against the contact surface 33 of the seatback sample 31 in the order in which various positions on the human back contact the seat back.

### Example 2

In the example where the sample 30 is a seat sample 32, the robotic arm 60 can drive the simulated hip-leg object 42 to contact and push against the contact surface 34 of the seat sample 32 in the order in which the various positions on the human buttocks and thigh roots contact the seat back.

### Example 3

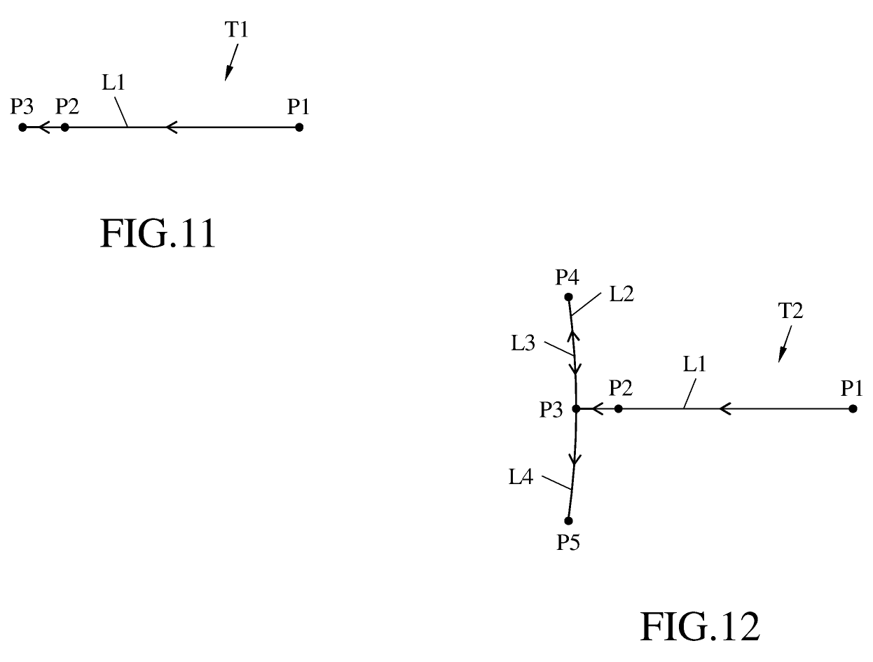

In the example where the sample 30 is a seatback sample 31, when the robotic arm 60 drives the simulated back object 41 to move, the simulated back object 41 (specifically, a portion of the simulated back object 41 (for example, but not limited to, the connection between the simulated back object 41 and the connecting member 80)) will move along a movement trajectory T1 as shown in FIG. 11. The movement trajectory T1 is a trajectory that simulates the normal movement of the occupant leaning against the seat back.

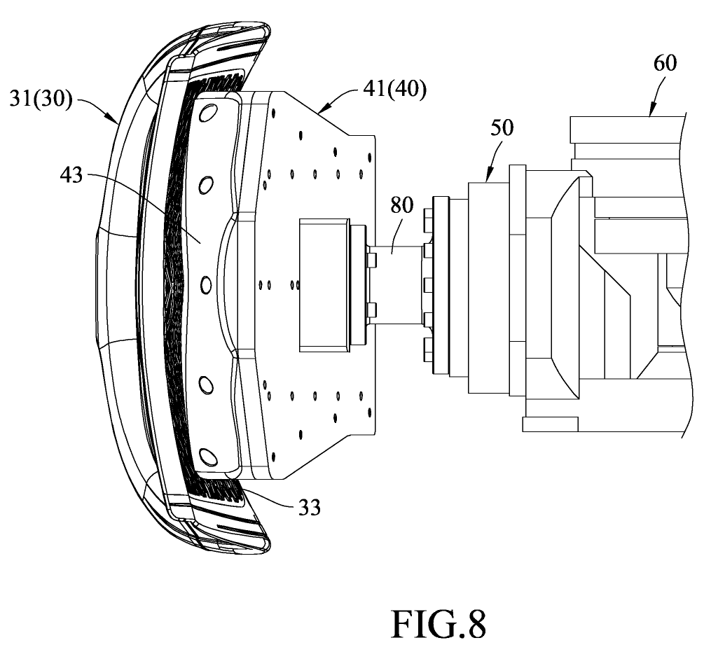

The movement trajectory T1 includes a forward path L1, which starts from an initial coordinate P1 far away from the seatback sample 31, through a surface contact coordinate P2, to an arrival coordinate of normal push P3. The arrival coordinate of normal push P3 is farther from the initial coordinate P1 than the surface contact coordinate P2. When the simulated back object 41 is located at the surface contact coordinate P2, the simulated back object 41 just contacts the contact surface 33 of the seatback sample 31 and the force sensing value has not reached the set value yet. When the simulated back object 41 is located at the arrival coordinate of normal push P3, the simulated back object 41 normally pushes against the seatback sample 31 as shown in FIG. 8, and the degree of pushing against the seatback sample 31 makes the force sensing value reach the set value.

When the simulated back object 41 reaches the arrival coordinate of normal push P3, it means that the movement trajectory T1 has been completed. At this time, the processor 71 can control the robotic arm 60 to drive the simulated back object 41 to leave the seatback sample 31. In this way, the execution of the above test procedure is completed once.

### Example 4

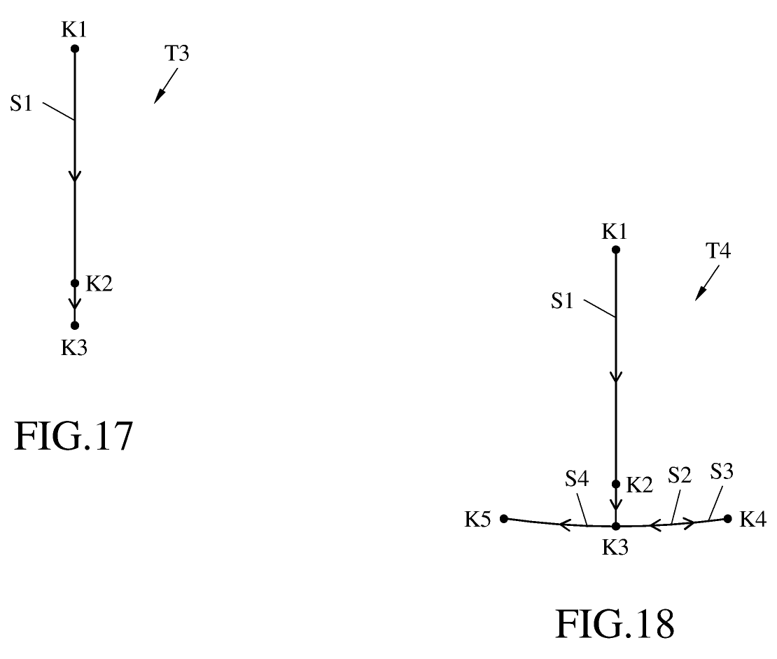

In the example where the sample 30 is the seat sample 32, when the robotic arm 60 drives the simulated hip-leg object 42 to move, the simulated hip-leg object 42 (specifically, a part of the simulated hip-leg object 42 (for example, but not limited to, the connection between the simulated hip-leg object 42 and the connecting member 80)) will move along an movement trajectory T3 as shown in FIG. 17. The movement trajectory T3 is a trajectory that imitates the trajectory in which the occupant normally presses down on the seat.

The movement trajectory T3 includes a forward path S1, which starts from an initial coordinate K1 far away from the seat sample 32, through a surface contact coordinate K2, to an arrival coordinate of normal push K3. The arrival coordinate of normal push K3 is farther from the initial coordinate K1 than the surface contact coordinate K2. When the simulated hip-leg object 42 is located at the surface contact coordinate K2, the simulated hip-leg object 42 just contacts the contact surface 34 of the seat sample 32 and the force sensing value has not reached the set value yet. When the simulated hip-leg object 42 is located at the arrival coordinate of normal push K3, the simulated hip-leg object 42 normally pushes (or presses down) the seat sample 32, and the degree of pushing (or pressing down) the seat sample 32 makes the force sensing value reach the set value.

When the simulated hip-leg object 42 reaches the arrival coordinate of normal push K3, it means that the movement trajectory T3 has been completed. At this time, the processor 71 can control the robotic arm 60 to drive the simulated hip-leg object 42 to leave the seat sample 32. In this way, the execution of the above-mentioned test procedure is completed once.

In addition, in the actual use scenario of the seat, the occupant may sit on the seat by an incorrect sitting posture, such as, but not limited to, the shifting of the center of gravity of the occupant sitting on the seat, the shifting of the position of the occupant pressing on the seat back, etc. Therefore, for these cases of incorrect sitting postures, the test method of the present invention further includes the following steps before step S16.

Step S18: when the force sensing value reaches the set value in step S14, the processor 71 will further determine whether the movement trajectory is completed. In the present invention, the database stores different motion parameter sequences. A motion parameter sequence corresponds to a human body movement and includes various parameters and the execution priority of each parameter required to instruct the robotic arm 60 to drive the pressuring member 40 to simulate a human body movement. Therefore, when the last coordinate parameter in the motion parameter sequence in cooperation with the above-mentioned test procedure is executed, it means that the movement trajectory has been completed. The last coordinate parameter in the motion parameter sequence can also be updated according to the changes in present various parameters used in the control of the robotic arm 60 when the force sensing value just reaches the set value during the last execution of the test procedure.

Therefore, the human body movement that can be simulated by the pressuring member 40 driven by the robotic arm 60 can have more variations. The following are illustrative examples.

### Example 5

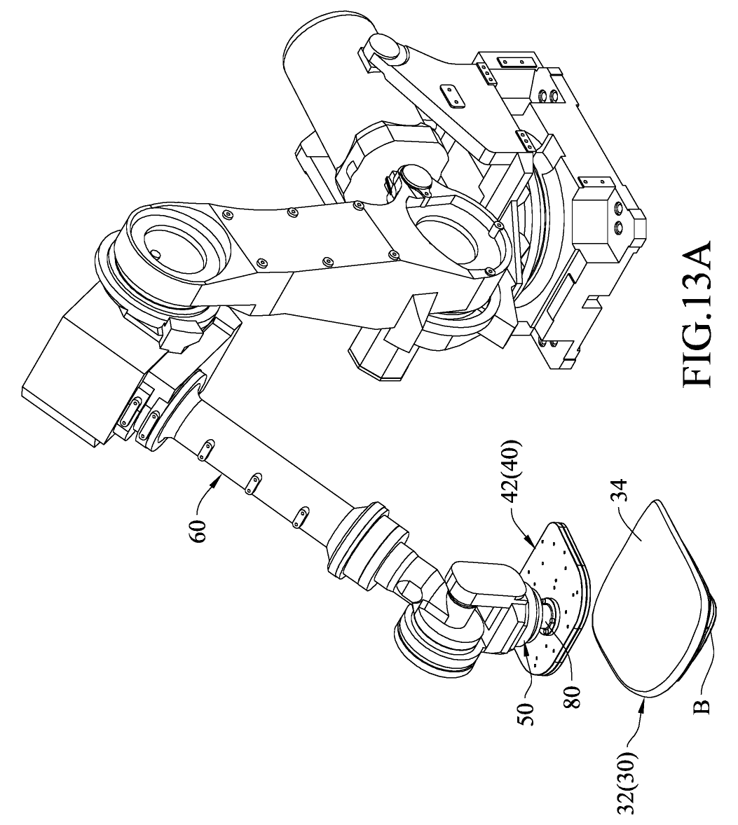

In the example where the sample 30 is the seatback sample 31, when the robotic arm 60 drives the simulated back object 41 to move, the simulated back object 41 moves along a movement trajectory T2 as shown in FIG. 12. The movement trajectory T2 is a trajectory that imitates the trajectory of an occupant leaning against the seat back abnormally.

In addition to the forward path L1 of FIG. 11, the movement trajectory T2 further includes a lateral path L2 following the forward path L1, a turning path L3 following the aforementioned lateral path L2, and a lateral path L4 following the turning path L3.

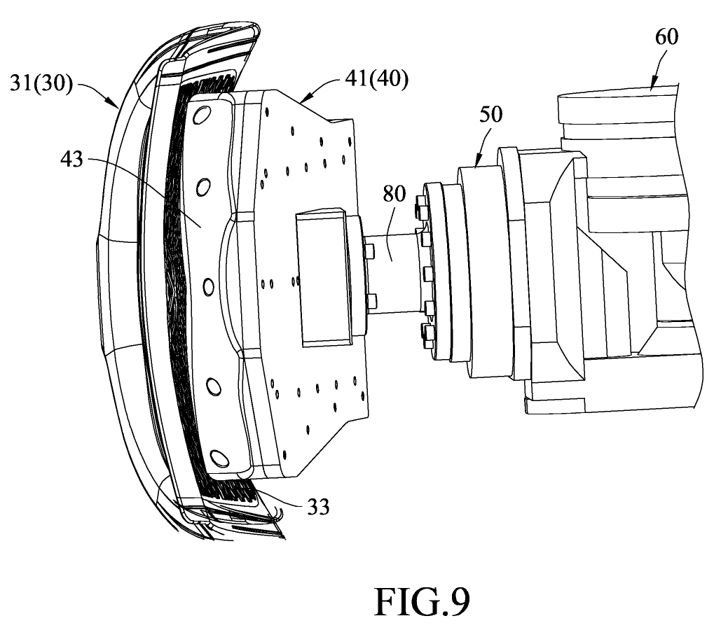

The lateral path L2 is from the arrival coordinate of normal push P3 to an arrival coordinate of oblique push P4. The arrival coordinate of oblique push P4 is farther from the initial coordinate P1 than the surface contact coordinate P2. When the simulated back object 41 is located at the arrival coordinate of oblique push P4, the simulated back object 41 pushes the seatback sample 31 obliquely as shown in FIG. 9, and the degree of pushing the seatback sample 31 makes the force sensing value reach the set value.

The turning path L3 is from the arrival coordinate of oblique push P4 back to the arrival coordinate of normal push P3. The turning path L3 completely coincides with the lateral path L2 (as shown in FIG. 12 ), or in addition to the coincidence of the arrival coordinate of normal push P3 and the arrival coordinate of oblique push P4, there are also other sections that partially coincide, or only the arrival coordinate of normal push P3 and the arrival coordinate of oblique push P4 coincide, and the remaining sections do not coincide.

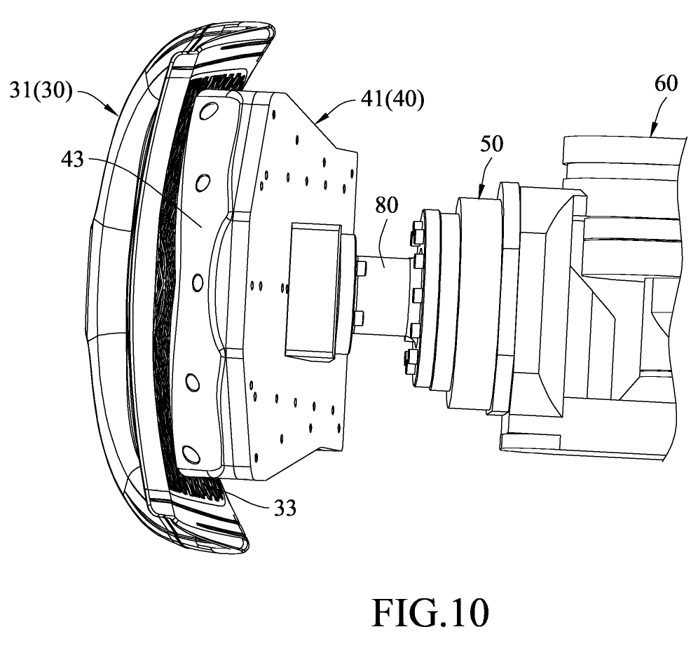

The lateral path L4 is from the arrival coordinate of normal push P3 to an arrival coordinate of oblique push P5. The arrival coordinate of oblique push P5 is farther from the initial coordinate P1 than the surface contact coordinate P2, and the arrival coordinate of normal push P3 is located between the arrival coordinates of oblique push P4 and P5. When the simulated back object 41 is located at the arrival coordinate of oblique push P5, the simulated back object 41 pushes against the seatback sample 31 obliquely as shown in FIG. 10, and the degree of pushing against the seatback sample 31 makes the force sensing value to reach the set value.

When the simulated back object 41 reaches the arrival coordinate of oblique push P5, it indicates that the movement trajectory T2 has been completed, and at this time the processor 71 can control the robotic arm 60 to drive the simulated back object 41 to leave the seatback sample 31. In this way, the above test procedure is executed once.

Optionally, when the simulated back object 41 is located at any position on the lateral path L2, the turning path L3 and the lateral path L4, the force sensing value is continuously maintained at the set value. Alternatively, when the simulated back object 41 is located at any position on the section of the lateral path L2 approaching the arrival coordinate of oblique push P4, at any position on the section of the turning path L3 approaching the arrival coordinate of normal push P3, and at any position on the section of the lateral path L4 approaching the arrival coordinate of oblique push P5, the force sensing value is continuously maintained at the set value. Alternatively, when the simulated back object 41 reaches the arrival coordinate of oblique push P4, reaches the arrival coordinate of normal push P3 in the turning path L3, and reaches the arrival coordinate of oblique push P5, the force sensing value reaches the set value.

### Example 6

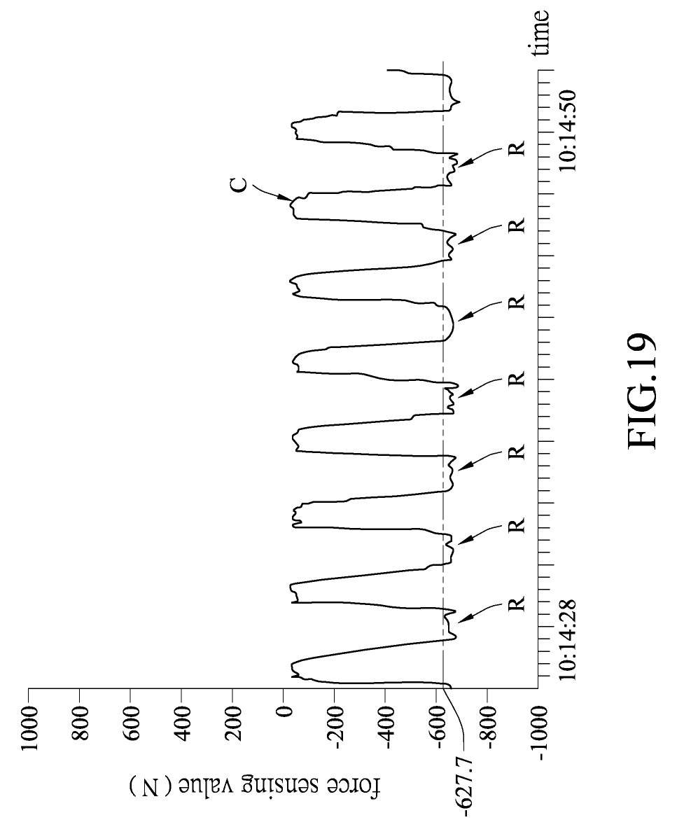

In the example where the sample 30 is the seat sample 32, when the robotic arm 60 drives the simulated hip-leg object 42 to move, the simulated hip-leg object 42 will move along a movement trajectory T4 as shown in FIG. 18. The movement trajectory T4 is a trajectory that simulates the occupant abnormally pressing down on the seat.

In addition to the forward path S1 shown in FIG. 17, the movement trajectory T4 further includes a lateral path S2 following the forward path S1, a turning path S3 following the lateral path S2, and a lateral path S4 following the turning path S3.

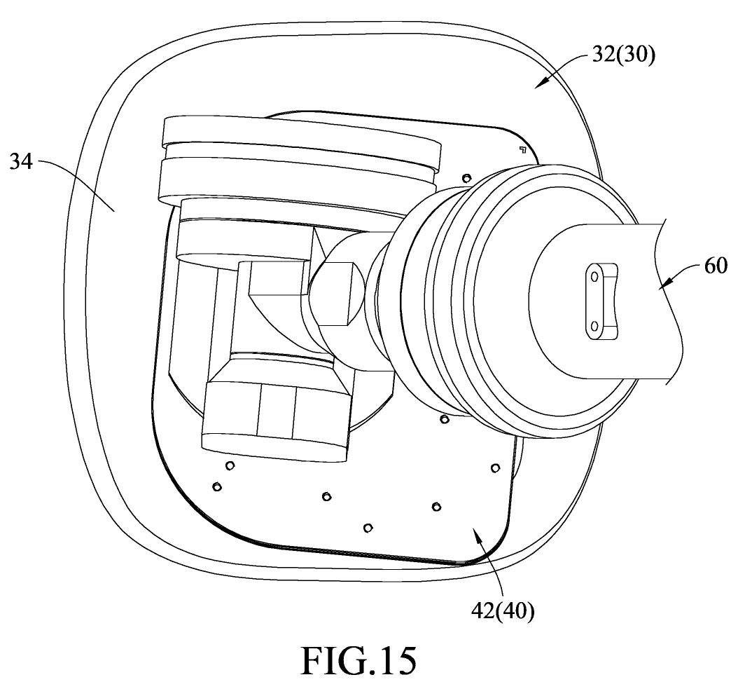

The lateral path S2 is from the arrival coordinate of normal push K3 to the arrival coordinate of oblique push K4. The arrival coordinate of oblique push K4 is farther from the initial coordinate K1 than the surface contact coordinate K2. When the simulated hip-leg object 42 is located at the arrival coordinate of oblique push K4, the simulated hip-leg object 42 pushes the seat sample 32 obliquely as shown in FIG. 15, and the degree of pushing the seat sample 32 makes the force sensing value reach the set value.

The turning path S3 is from the arrival coordinate of oblique push K4 to the arrival coordinate of normal push K3. The turning path S3 completely coincides with the lateral path S2 (as shown in FIG. 18), or in addition to the coincidence at the arrival coordinate of normal push K3 and the arrival coordinate of oblique push K4, there are also other sections that partially coincide, or only the arrival coordinate of normal push K3 and the arrival coordinate of oblique push K4 coincide, and the remaining sections do not coincide.

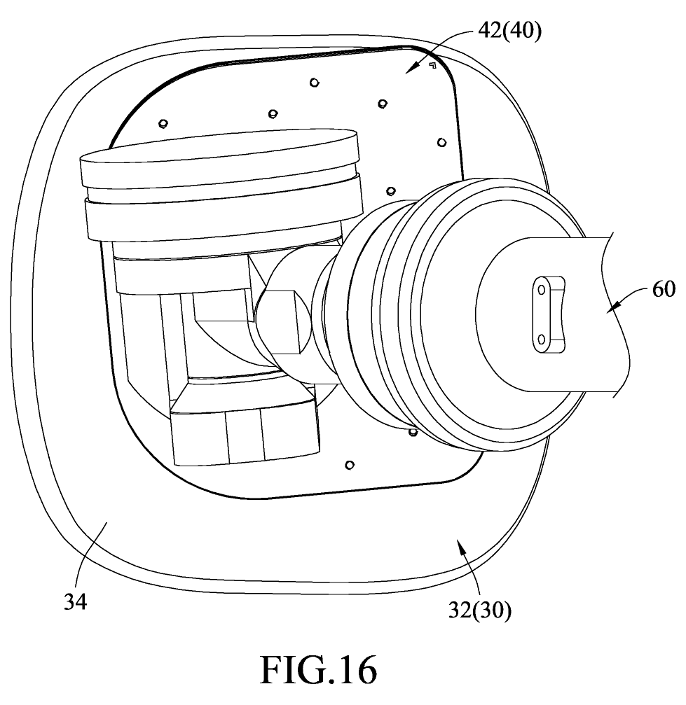

The lateral path S4 is from the arrival coordinate of normal push K3 to the arrival coordinate of oblique push K5. The arrival coordinate of oblique push K5 is farther from the initial coordinate K1 than the surface contact coordinate K2, and the arrival coordinate of normal push K3 is located between the arrival coordinates of oblique push K4 and K5. When the simulated hip-leg object 42 is located at the arrival coordinate of oblique push K5, the simulated hip-leg object 42 pushes the seat sample 32 obliquely as shown in FIG. 16, and the degree of pushing the seat sample 32 makes the force sensing value to reach the set value.

When the simulated hip-leg object 42 reaches the arrival coordinate of oblique push K5, it indicates that the movement trajectory T4 has been completed. At this time, the processor 71 can control the robotic arm 60 to drive the simulated hip-leg object 42 to leave the seat sample 32. In this way, the execution of the above test procedure is completed once.

Optionally, when the simulated hip-leg object 42 is located at any position on the lateral path S2, the turning path S3, and the lateral path S4, the force sensing value is continuously maintained at the set value. Alternatively, when the simulated hip-leg object 42 is located at any position approaching the arrival coordinate of oblique push K4 on the lateral path S2, at any position approaching the arrival coordinate of normal push K3 on the turning path S3, and at any position approaching the coordinate K5 on the lateral path S4, the force sensing value is continuously maintained at the set value. Alternatively, when the simulated hip-leg object 42 reaches the arrival coordinate of oblique push K4, reaches the arrival coordinate of normal push K3 on the turning path S3, and reaches the coordinate K5, the force sensing value reaches the set value.

In the test procedure of the present invention, a time parameter of push may even be included optionally. This time parameter of push can instruct the processor 71 of the server 70 to control the robotic arm 60 to drive the pressuring member 40 to continuously push the sample 30 so that the force sensing value continues to reach the set value for a period of time.

Taking the above-mentioned Example 6 as an example, the robotic arm 60 can be controlled to drive the simulated hip-leg object 42 to continuously push the seat sample 32 at the arrival coordinate of normal push K3, the arrival coordinate of oblique push K4 and the arrival coordinate of oblique push K5 respectively, so that the force sensing value at either of these arrival coordinates continuously reaches the set value for a period of time.

On the other hand, although the sample 30 in the above-mentioned embodiments or examples imitates a single chair part and is only used to test the properties of the imitated chair part, the present invention is not limited thereto. In other embodiments, the sample 30 can also imitate multiple chair parts and can be used to test the properties of any one of the imitated chair parts or to test the properties of these chair parts at the same time, and these chair parts can be assembled together or form an one-piece structure. The following examples are given for illustration, but the present invention is not limited to these examples.

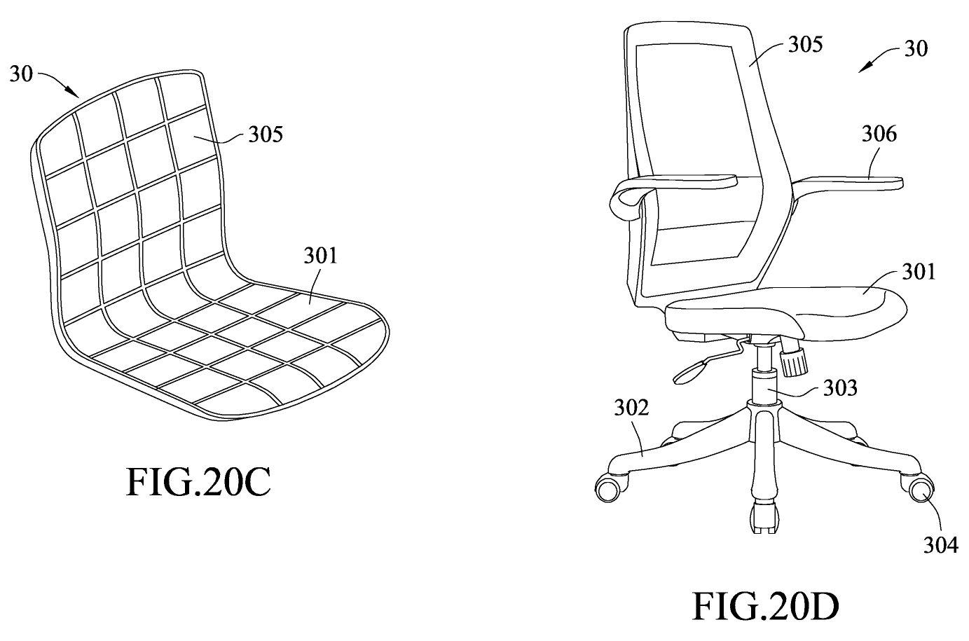

In the example shown in FIG. 20A, the sample 30 is a structure formed by assembling a seat 301 and chair legs 302 together, so when a pressuring member is used to push against the seat 301, the properties of the seat 301 and the chair legs 302 can be tested simultaneously.

In the example shown in FIG. 20B, the sample 30 is a structure formed by assembling a seat 301, chair legs 302, a lifting column 303, and wheels 304 together, so when a pressuring member is used to push against the seat 301, the properties of the seat 301, the chair legs 302, the lifting column 303, and the wheels 304 can be tested simultaneously.

In the example shown in FIG. 20C, the sample 30 is an integrally formed structure having a seat 301 and a seat back 305. Therefore, when a pressure is applied to the seat 301, the properties of the seat 301 can be tested, and when a pressure is applied to the seat back 305, the properties of the seat back 305 can be tested.

In the example shown in FIG. 20D, the sample 30 is the seat itself. Therefore, when a pressure is applied to the seat 301, the properties of the seat , the chair legs 302, the lifting column 303 and the wheels 304 can be tested simultaneously. When a pressure is applied to the seat back 305, the properties of the seat back 305 can be tested. When a pressure is applied to the armrest 306, the properties of the armrest 306 can be tested.

In summary, the present invention can ensure that each time the sample 30 is pushed or pressed down, the force borne by the sample 30 can stably match the human's weight, by detecting the reaction force transmitted from the pressuring member 40, thereby simulating the state of the seat when it is actually occupied. The present invention can also use an imitation of body parts as the pressuring member 40 to make each pushing or pressing down of the sample 30 closer to the state of the chair parts being pressed during actual use. The present invention can also simulate different usage states by designing a movement trajectory. Even more, the present invention can make each pushing or pressing down of the sample 30 more like the state of the chair parts being pressed during actual use, by designing the duration of the push or press. In this way, the present invention can make the test results closer to the properties of the chair parts in actual use.

Although the present invention is disclosed as above with the aforementioned embodiments, these embodiments are not used to limit the present invention. Without departing from the spirit and scope of the present invention, the changes, modifications and combinations of various embodiments are all within the scope of patent protection of the present invention. For the scope of protection defined by the present invention, please refer to the attached claims.

What is claimed is:

1. A test system for a chair, suitable for testing properties of a chair part by using a sample associated with a chair part of the chair, and comprising:
a pressuring member;
a force sensor connected to the pressuring member;
a robotic arm connected to the force sensor; and
a server communicable with the force sensor and the robotic arm to repeatedly execute a test procedure according to a preset number of tests to test the sample, and whenever the test procedure is executed, the server configured to:
control the robotic arm to drive the pressuring member to approach and push against the sample;
control the force sensor to detect a reaction force transmitted from the pressuring member pushing against the sample, to generate a force sensing value;
receive the force sensing value from the force sensor to determine whether the force sensing value reaches a set value that is related to human’s weight; and
control the robotic arm to drive the pressuring member to leave the sample, when the force sensing value reaches the set value.

2. The test system for the chair as claimed in claim 1, wherein the server controls the robotic arm to drive the pressuring member to simulate a human body movement to approach and push against the sample, and the human body movement refers to a movement of a human sitting down.

3. The test system for the chair as claimed in claim 2, wherein the pressuring member has a movement trajectory when moving according to the human body movement, the movement trajectory includes a forward path, the forward path starts from an initial coordinate far away from the seat sample, through a surface contact coordinate, to an arrival coordinate of normal push, the arrival coordinate of normal push is farther from the initial coordinate than the surface contact coordinate, the pressuring member initially contacts the contact surface of the seat sample when located at the surface contact coordinate, and the force sensing value reaches the set value when the pressuring member is located at the arrival coordinate of normal push;
the movement trajectory further includes a lateral path following the forward path, the lateral path is from the arrival coordinate of normal push to an arrival coordinate of oblique push, the arrival coordinate of oblique push is farther from the initial coordinate than the surface contact coordinate, and when the pressuring member is located at the arrival coordinate of oblique push, the force sensing value reaches the set value; and
when the movement trajectory is completed and the force sensing value reaches the set value, the server controls the robotic arm to drive the pressuring member to leave the sample.

4. The test system for the chair as claimed in claim 3, wherein the movement trajectory further includes a turning path following the lateral path, the turning path is from the arrival coordinate of oblique push back to the arrival coordinate of normal push; and
the movement trajectory further includes another lateral path following the turning path, the another lateral path is from the arrival coordinate of normal push to another arrival coordinate of oblique push, the another arrival coordinate of oblique push is farther from the initial coordinate than the surface contact coordinate, and the arrival coordinate of normal push is located between the arrival coordinates of oblique push, and when the pressuring member is located at the another arrival coordinate of oblique push, the force sensing value reaches the set value.

5. The test system for the chair as claimed in claim 1, wherein the test procedure includes a time parameter of push, the time parameter of push instructs the server to control the pressuring member to continuously push the sample so that the force sensing value continues to reach the set value for a period of time.

6. The test system for the chair as claimed in claim 1, wherein the sample imitates multiple chair parts of the chair and is used to test properties of any one of the chair parts, and these chair parts are allowed to be assembled together or form an integrally formed structure.

7. The test system for the chair as claimed in claim 1, wherein the sample imitates multiple chair parts of the chair and is used to test properties of these chair parts at the same time, and these chair parts are allowed to be assembled together or form an integrally formed structure.

8. The test system for the chair as claimed in claim 1, wherein the chair part is a seat back, a seat, a cushion, an armrest, a headrest, a chair leg, a lifting column or a wheel.

9. The test system for the chair as claimed in claim 1, wherein the pressuring member is an imitation of body parts, the imitation of body parts includes a pressuring surface for contacting the sample, and a surface shape of the pressuring surface imitates a surface shape of a body part used to contact the chair part.

10. The test system for the chair as claimed in claim 9, wherein when the chair part is a seat back, the surface shape of the pressuring surface of the imitation of body parts imitates a surface shape of human back; and when the chair part is a seat, the surface shape of the pressuring surface of the imitation of body parts imitates surface shapes of buttocks and thigh roots.

11. A test method for a chair, suitable for testing properties of a chair part of the chair, and comprising the following steps:
(A) controlling a robotic arm to drive a pressuring member to approach and push against a sample associated with the chair part;
(B) controlling a force sensor to detect a reaction force transmitted from the pressuring member pushing against the sample, to generate a force sensing value;
(C) receiving the force sensing value from the force sensor to determine whether the force sensing value reaches a set value that is related to human's weight; and
(D) controlling the robotic arm to drive the pressuring member to leave the sample, when the force sensing value reaches the set value;
wherein the steps (A) to (D) are performed by a server repeatedly executing a test procedure according to a preset number of tests.

12. The test method for the chair as claimed in claim 11, wherein in the step (A), the robotic arm drives the pressuring member to simulate a human body movement to approach and push against the sample, and the human body movement refers to a movement of a human sitting down.

13. The test method for the chair as claimed in claim 12, wherein the pressuring member has a movement trajectory when moving according to the human body movement, the movement trajectory includes a forward path, the forward path starts from an initial coordinate far away from the seat sample, through a surface contact coordinate, to an arrival coordinate of normal push, the arrival coordinate of normal push is farther from the initial coordinate than the surface contact coordinate, the pressuring member initially contacts the contact surface of the seat sample when located at the surface contact coordinate, and the force sensing value reaches the set value when the pressuring member is located at the arrival coordinate of normal push;
the movement trajectory further includes a lateral path following the forward path, the lateral path is from the arrival coordinate of normal push to an arrival coordinate of oblique push, the arrival coordinate of oblique push is farther from the initial coordinate than the surface contact coordinate, and when the pressuring member is located at the arrival coordinate of oblique push, the force sensing value reaches the set value; and
in the step (D), when the movement trajectory is completed and the force sensing value reaches the set value, the server controls the robotic arm to drive the pressuring member to leave the sample.

14. The test method for the chair as claimed in claim 13, wherein the movement trajectory further includes a turning path following the lateral path, the turning path is from the arrival coordinate of oblique push back to the arrival coordinate of normal push; and
the movement trajectory further includes another lateral path following the turning path, the another lateral path is from the arrival coordinate of normal push to another arrival coordinate of oblique push, the another arrival coordinate of oblique push is farther from the initial coordinate than the surface contact coordinate, and the arrival coordinate of normal push is located between the arrival coordinates of oblique push, and when the pressuring member is located at the another arrival coordinate of oblique push, the force sensing value reaches the set value.

15. The test method for the chair as claimed in claim 11, wherein the test procedure includes a time parameter of push, the time parameter of push instructs the server to control the pressuring member to continuously push the sample so that the force sensing value continues to reach the set value for a period of time.

16. The test method for the chair as claimed in claim 11, wherein the sample imitates multiple chair parts of the chair and is used to test properties of any one of the chair parts, and these chair parts are allowed to be assembled together or form an integrally formed structure.

17. The test method for the chair as claimed in claim 11, wherein the sample imitates multiple chair parts of the chair and is used to test properties of these chair parts at the same time, and these chair parts are allowed to be assembled together or form an integrally formed structure.

18. The test method for the chair as claimed in claim 11, wherein the chair part is a seat back, a seat, a cushion, an armrest, a headrest, a chair leg, a lifting column or a wheel.

19. The test method for the chair as claimed in claim 11, wherein the pressuring member is an imitation of body parts, the imitation of body parts includes a pressuring surface for contacting the sample, and a surface shape of the pressuring surface imitates a surface shape of a body part used to contact the chair part.

20. The test method for the chair as claimed in claim 19, wherein when the chair part is a seat back, the surface shape of the pressuring surface of the imitation of body parts imitates a surface shape of human back; and when the chair part is a seat, the surface shape of the pressuring surface of the imitation of body parts imitates surface shapes of buttocks and thigh roots.
